(19) United States
(12) Patent Application Publication
(10) Pub. No.: US 2026/0012389 A1
(43) Pub. Date: Jan. 8, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YU KAWAI, Kanagawa (JP)

(21) Appl. No.: 19/254,642

(22) Filed: Jun. 30, 2025

(30) Foreign Application Priority Data
Jul. 3, 2024 (JP) 2024-107516

(51) Int. Cl. H04L 41/0806; G06F 3/04817; G06F 3/04842

(52) U.S. Cl. CPC H04L 41/0806; G06F 3/04817; G06F 3/04842

(57) ABSTRACT

A first application program is provided, which causes an information processing apparatus to display on a display unit of the information processing apparatus a password input screen including a first area configured to receive, from a user, an input of a password for connecting a communication device to an access point outside the information processing apparatus and a second area for presenting, to the user, a confirmation method for the user to confirm the password on a screen displayed on the display unit by a second application program different from the first application program, and transmit setting information including at least the password input by the user on the password input screen to the communication device via a connection between the information processing apparatus and the communication device. The communication device uses the setting information transmitted by the information processing apparatus to connect to the access point.

### BACKGROUND

### Field of the Technology

The present disclosure relates to an information processing apparatus, a control method, and a storage medium.

### Description of the Related Art

There is a known configuration in which an information processing apparatus, such as a smartphone, transmits information for connecting to an access point to a communication device, such as a printer, to enable the communication device to connect to the access point using the information. Japanese Patent Laid-Open No. 2016-127545 describes an information processing apparatus configured to set a connection mode for determining a connection configuration between the information processing apparatus and a communication device in the communication device by transmitting information to the communication device.

As the configuration in which information for connecting the communication device to an access point becomes widespread, there is a growing demand for improving the usability of application programs that perform processing for transmitting the information for connecting to the access point to the communication device.

### SUMMARY

The present disclosure is directed to improve the usability of application programs that perform processing for transmitting information for connecting to an access point to a communication device.

A first application program according to an aspect of the present disclosure causes a computer of an information processing apparatus to execute a control method comprising the steps of: displaying on a display unit of the information processing apparatus a password input screen including a first area configured to receive, from a user, an input of a password for connecting a communication device to an access point outside the information processing apparatus and a second area for presenting, to the user, a confirmation method for the user to confirm the password on a screen displayed by a second application program different from the first application program in the information processing apparatus, and transmitting setting information including at least the password input by the user on the password input screen to the communication device via a connection between the information processing apparatus and the communication device, wherein the communication device uses the setting information transmitted by the information processing apparatus to connect to the access point.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a communication system according to an embodiment.

FIG. 2 is a block diagram illustrating an example of a terminal device and a communication device according to an embodiment.

FIGS. 3A and 3B show a flowchart illustrating an example of processing executed by a terminal device using a first application according to an embodiment.

FIG. 4 is a diagram illustrating an example of a screen for a direct connection according to an embodiment.

FIG. 5 is a diagram illustrating an example of a password input screen according to an embodiment.

FIG. 6A is a diagram illustrating an example of a password confirmation screen according to an embodiment.

FIG. 6B is a diagram illustrating an example of a password confirmation screen according to an embodiment.

FIG. 7 is a flowchart illustrating an example of processing executed by a terminal device using a first application according to an embodiment.

FIG. 8 is a diagram illustrating an example of a confirmation screen according to an embodiment.

### DESCRIPTION OF THE EMBODIMENTS

### First Embodiment

An information processing apparatus and a communication device included in a communication system according to the present embodiment will be described. The information processing apparatus is also referred to as a terminal device. Although the present embodiment illustrates a smartphone as an example of the information processing apparatus, this is intended as an example only. Other examples of the information processing apparatus include a personal computer (PC), a tablet terminal, a personal digital assistant (PDA), a digital camera, and various other applicable devices. This embodiment illustrates a printer as an example of the communication device. The printer may be either an ink-jet printer that prints with ink or a laser-beam printer that prints with toner. The printer may be either a full-color printer capable of color printing or a monochrome printer capable of monochrome printing, rather than color printing. In the present embodiment, the communication device is not limited to printers and may be any various other communication devices capable of wireless communication with the information processing apparatus. Other examples of the communication device include a copying machine, a facsimile machine, a scanner, a smartphone, a PC, a tablet terminal, a PDA, a digital camera, a music playback device, a television set, a smart speaker, a robotic cleaner, an automatic cooker, a refrigerator, and various other applicable devices. Other examples include multifunctional peripherals having multiple functions, such as a copying function, a FAX function, and a printing function.

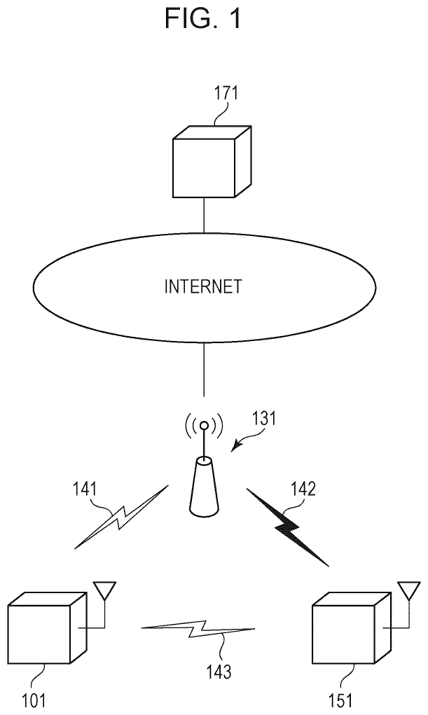

First, a system configuration for implementing the present embodiment will be described. FIG. 1 is a diagram illustrating an example of the configuration of a communication system according to the present embodiment. This system includes a communication device 151, a terminal device 101, an access point (AP) 131, and an external server 171.

The terminal device 101 is an information processing apparatus according to the present embodiment. The communication device 151 is a communication device according to the present embodiment. The AP 131 is an access point activated by an external device that is present outside the terminal device 101 and the communication device 151. One example of the external device is a wireless local area network (LAN) router. The external server 171 is a server capable of providing services to a device connected to the AP 131 via the Internet.

In a state in which the communication device 151 and the terminal device 101 are connected to the AP 131, the LAN formed by the AP 131 includes the AP 131, the communication device 151, and the terminal device 101. In contrast, a wide area network (WAN) includes the AP 131 and the external server 171.

In the present embodiment, in a case where an infrastructure connection described later is established, the terminal device 101 can communicate with the communication device 151 via the AP 131. In a case where a direct connection described later is established, the terminal device 101 can directly communicate with the communication device 151 not via the AP 131. In the following, the connection to the AP 131 corresponds to a connection to a network formed by the AP 131. A single external device may activate multiple APs and can simultaneously form multiple networks.

In the present embodiment, a connection 141 between the terminal device 101 and the AP 131, and a connection 142 between the communication device 151 and the AP 131 are connections using a communication scheme based on the IEEE802.11 series of standards. The communication scheme based on the IEEE802.11 series of standards is, specifically, Wireless Fidelity (Wi-Fi)®. However, the connection 141 and the connection 142 are not limited to this communication scheme. For example, the connection 141 between the terminal device 101 and the AP 131 and the connection 142 between the communication device 151 and the AP 131 may be connections via a wired LAN. In the present embodiment, a connection 143 between the terminal device 101 and the communication device 151 is also a connection using the communication scheme based on the IEEE802.11 series of standards. However, the communication scheme for use in the connection 143 is not limited to this configuration; for example, Bluetooth® Low Energy (BLE), Bluetooth Classic, Wi-Fi Aware, and Near Field Communication (NFC) are possible. The AP 131 and the external server 171 can communicate with each other via the Internet. In a state in which the AP 131 is connected to the Internet, the devices (the terminal device 101 and the communication device 151) connected to the AP 131 can also access the Internet.

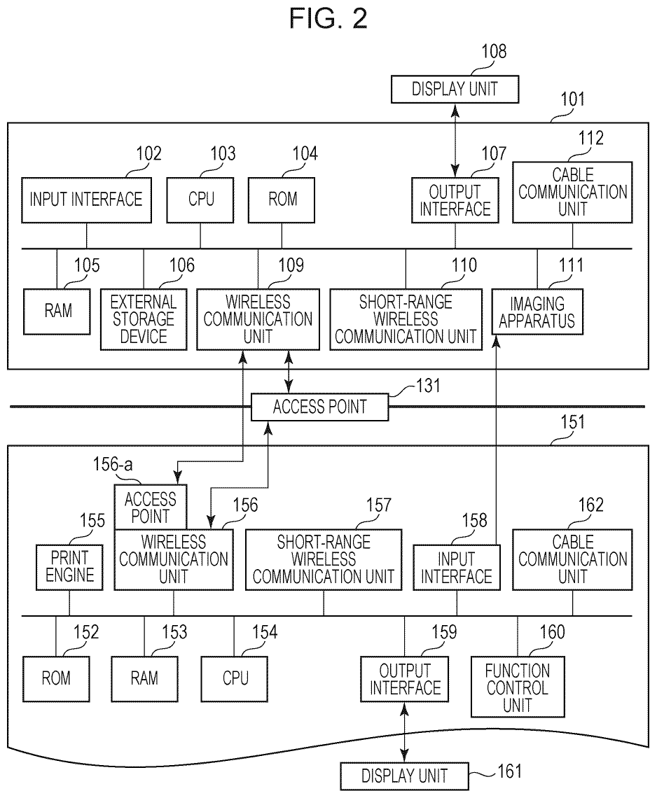

Next, the configuration of an information processing apparatus and a communication device that can communicate with the information processing apparatus according to the present embodiment will be described with reference to the block diagram of FIG. 2. Although the present embodiment is described using the following configuration as an example, the present embodiment is applicable to any apparatus capable of communicating with a communication device, and the functions are not limited to the functions of FIG. 2.

The terminal device 101 includes an input interface 102, a central processing unit (CPU) 103, a read-only memory (ROM) 104, a random-access memory (RAM) 105, an external storage device 106, an output interface 107, a display unit 108, a wireless communication unit 109, a short-range wireless communication unit 110, an imaging apparatus 111, and a cable (wired) communication unit 112. The CPU 103, the ROM 104, the RAM 105, and so on constitute the computer of the terminal device 101.

The input interface 102 is an interface for receiving data input and operation instructions from a user. Examples include a physical keyboard, buttons, and a touch panel. The output interface 107, described later, and the input interface 102 may have a similar configuration, and output to a screen and reception of operations from the user may be performed using the same configuration.

The CPU 103 is a system control unit and controls the overall terminal device 101. In the present embodiment, the CPU 103 performs processes including control of the display contents of the display unit 108 (display control).

The ROM 104 stores fixed data, such as control programs executed by the CPU 103, data tables, and an operating system (hereinafter referred to as an OS) program. In the present embodiment, the control programs stored in the ROM 104 perform software execution control, such as scheduling, task switching, and interrupt processing, under a built-in OS stored in the ROM 104. In the present embodiment, the ROM 104 stores a predetermined application program (app) for controlling the communication device 151. In other words, the application program is application software. The predetermined application is installed in the terminal device 101 from an external source, for example, via a store application for installing various applications. The predetermined application is provided by the vendor of the communication device 151. In the present embodiment, the predetermined application is an application for setting a connection to the communication device 151 by communicating with the communication device 151. In the following description, the predetermined application is referred to as a first application. The first application may have other functions other than the function for setting the connection to the communication device 151. Specific examples of the other functions include a function for transmitting a print job to cause the communication device 151 to execute printing (a print job transmission function) and a function for transmitting a scan job to cause the communication device 151 to execute scanning (a scan job transmission function). The processes that are described as processes to be executed by the OS in the present embodiment are, in fact, processes executed by the CPU 103 according to the programs in the OS. Similarly, the processes to be executed by the application are, in fact, processes executed by the CPU 103 according to the programs in the application.

The RAM 105 is a static random-access memory (SRAM) or the like that requires a backup power supply. The RAM 105 stores data using a primary backup battery (not shown) and can therefore store important data such as program control variables in a volatile manner. The RAM 105 further includes a memory area for storing setting information about the terminal device 101 and management data about the terminal device 101. The RAM 105 is also used as a main memory and a work memory for the CPU 103.

The external storage device 106 includes a printing information generation program for generating printing information that can be interpreted by the communication device 151, an information transmission/reception control program for transmitting/receiving information to/from the communication device 151 connected via the wireless communication unit 109, and various other programs. The external storage device 106 also stores various pieces of information to be used by the programs and image data acquired from other information processing apparatuses or the Internet.

The output interface 107 is an interface that controls the display unit 108 to display data and provide notification indicating the state of the terminal device 101.

The display unit 108 is, for example, a light-emitting diode (LED) or a liquid-crystal display (LCD) and displays data and provides notification indicating the state of the terminal device 101. By displaying a software keyboard including a numeric input key, a mode setting key, an enter key, a cancel key, and a power key on the display unit 108, input from the user may be received via the display unit 108. In the present embodiment, the display unit 108 is a touch panel, enabling operations using fingers or an operation member, such as a pen, to be received from the user.

The wireless communication unit 109 is configured to connect wirelessly to the communication device 151, the AP 131, or another device to perform data communication. For example, the wireless communication unit 109 may communicate with the communication device 151 using wireless communication either directly or via the AP 131 present outside the terminal device 101 and the communication device 151. In the present embodiment, the wireless communication scheme of the wireless communication unit 109 is Wi-Fi, which is a communication scheme based on the IEEE802.11 standard, but Bluetooth Classic or the like may be used. In the present embodiment, the wireless LAN is a network via Wi-Fi. In the present embodiment, the connection between the terminal device 101 and the communication device 151 using the direct communication scheme not via an external AP is referred to as a direct connection. The connection between the terminal device 101 and the communication device 151 using the scheme via an external AP is referred to as an infrastructure connection.

The short-range wireless communication unit 110 is configured to execute data communication with the communication device 151 or the like using a short-range wireless communication scheme and performs communication using a communication scheme different from that of the wireless communication unit 109. The short-range wireless communication unit 110 is capable of connecting to the short-range wireless communication unit 157 in the communication device 151. Examples of the communication scheme of the short-range wireless communication unit 110 include Bluetooth low energy (BLE), Bluetooth Classic, Wi-Fi Aware, and Near field communication (NFC).

The imaging apparatus 111 is a device that converts images captured by an image sensor to digital data.

The digital data is first stored in the RAM 105. Thereafter, the digital data is converted to a predetermined image format by a program executed by the CPU 103 and stored as image data in the external storage device 106.

The cable communication unit 112 is configured to connect to the communication device 151, the AP 131, or another device by wire to execute data communication. For example, the cable communication unit 112 performs communication via a wired LAN. In the present embodiment, the wired LAN communicates in accordance with the Ethernet standard; however, this configuration is illustrative only. The cable communication unit 112 may perform communication, for example, via a universal serial bus (USB) cable. If the terminal device 101 is a smartphone, the terminal device 101 does not necessarily have to include the cable communication unit 112.

The communication device 151 includes a ROM 152, a RAM 153, a CPU 154, a print engine 155, a wireless communication unit 156, a short-range wireless communication unit 157, an input interface 158, an output interface 159, a function control unit 160, a display unit 161, and a cable communication unit 162.

The ROM 152, the RAM 153, the CPU 154, and so on constitute the computer of the communication device 151.

The wireless communication unit 156 is configured to connect wirelessly to the terminal device 101, the AP 131, or another device to perform data communication. In the present embodiment, the wireless communication scheme of the wireless communication unit 109 is Wi-Fi, which is a communication scheme based on the IEEE802.11 standard, but Bluetooth Classic or the like may be used. The wireless communication unit 156 includes an AP 156-a for connecting to the terminal device 101 or another device. The AP 156-a is capable of connecting to the wireless communication unit 109. The wireless communication unit 156 may directly communicate with the terminal device 101 via the AP 156-a or may communicate with the terminal device 101 via the AP 131. The AP 156-a may be hardware that functions as an AP, or the wireless communication unit 156 may operate as the AP 156-a by using software for enabling the wireless communication unit 156 to function as an AP. The communication device 151 may be configured to activate multiple APs with different service set identifiers (SSIDs) or passwords.

The RAM 153 is a dynamic RAM (DRAM) that requires a backup power supply. Data is retained by the RAM 153 supplied with power from a backup battery (not shown). Therefore, the RAM 153 can store important data, such as variables for program control, without volatilizing them. The RAM 153 is also used as the main memory and a work memory for the CPU 154 and stores a reception buffer for temporarily storing printing information received from the terminal device 101 or the like and various other pieces of information.

The ROM 152 stores fixed data, such as control programs to be executed by the CPU 154, data tables, and an OS program. In the present embodiment, the control programs stored in the ROM 152 perform software execution control, such as scheduling, task switching, and interrupt processing, under a built-in OS stored in the ROM 152. The ROM 152 further includes a memory area for storing data to be retained even when no power is supplied, such as setting information about the communication device 151 and management data about the communication device 151.

The CPU 154 is a system control unit and controls the overall communication device 151.

The print engine 155 outputs a print result by forming an image on a print medium, such as paper, using a printing agent, such as ink, in accordance with information stored in the RAM 153 and a print job received from the terminal device 101. The print job received from the terminal device 101 or the like has a large amount of transmit data and requires high-speed communication and is therefore received via the wireless communication unit 156, which is capable of communication at higher speed than the short-range wireless communication unit 157.

The short-range wireless communication unit 157 is configured to communicate with the terminal device 101 or the like using a short-range wireless communication scheme. Examples of the communication scheme of the short-range wireless communication unit 157 include BLE, Bluetooth Classic, and Wi-Fi Aware.

The input interface 158 is an interface for receiving data input and operation instructions from a user. Examples include a physical keyboard, buttons, and a touch panel. The output interface 159, described later, and the input interface 158 may have a similar configuration, and output to a screen and reception of operations from the user may be performed using the same configuration. The output interface 159 is an interface that controls the display unit 161 to display data and provide notification indicating the state of the communication device 151.

The function control unit 160 manages a functional operation to operate the functions of the communication device 151 simultaneously or not.

The display unit 161 is, for example, a light-emitting diode (LED) or a liquid crystal display (LCD) and displays data and provides notification indicating the state of the communication device 151. By displaying a software keyboard including a numeric input key, a mode setting key, an enter key, a cancel key, and a power key on the display unit 161, input from the user may be received via the display unit 161.

The cable communication unit 162 is configured to connect to the terminal device 101, the AP 131, or another device by wire to execute data communication. For example, the cable communication unit 162 performs communication via a wired LAN; however, this configuration is illustrative only. The cable communication unit 162 may perform communication, for example, via a USB cable.

### Direct Connection Scheme

Direct connection refers to a configuration in which devices are connected to each other directly (that is, peer-to-peer) not via an external device, such as the AP 131. The direct connection is also referred to as a peer-to-peer connection (P2P connection). The communication device 151 is operable in a mode for communication via a direct connection as one of connection modes (a direct connection mode). In Wi-Fi communication, there are multiple modes for communication via a direct connection, such as a software AP mode or Wi-Fi Direct (WFD) mode.

A mode for executing a direct connection via WFD is referred to as a WFD mode. WFD is a standard established by the Wi-Fi Alliance and is included in the communication standards of the IEEE802.11 series. In the WFD mode, after a device serving as a communications partner is discovered in response to a device search command, the roles of the group owner (GO) and the P2P client are determined, and then the remaining process for the wireless connection is performed. The group owner corresponds to the parent station (base station) of Wi-Fi, and the client corresponds to the child station (remote station) of Wi-Fi. This role determination corresponds to, for example, GO Negotiation in P2P. In the WFD mode, before the role determination is performed, the communication device 151 is neither the parent station nor the child station. Specifically, one of the devices issues a device search command to search for a device to be connected in the WFD mode. When the other device serving as a communication partner is discovered, both devices confirm information about services and functions they can provide. Note that this confirmation of device capability information is optional and not mandatory. The device-capability-information confirmation phase corresponds to, for example, Provision Discovery of the P2P connection. Next, by confirming the device capability information with each other, it is determined which device serves as the P2P client, and which device serves as the group owner. Next, when the client and the group owner are determined, parameters for communication via WFD are exchanged between them. The remaining processes for the wireless connection and the IP connection are performed between the client and the group owner of the P2P connection based on the exchanged parameters. In the WFD mode, the communication device 151 may always operate as the GO without executing GO Negotiation described above. In other words, the communication device 151 may operate in the WFD mode, which is an Autonomous GO mode. Examples of the state in which the communication device 151 operates in the WFD mode include a state in which the WFD connection is not established, but the communication device 151 is operating as the GO and a state in which the WFD connection is established, and the communication device 151 is operating as the GO.

In the software AP mode, one of the devices (for example, the terminal device 101 or the communication device 151) serves as the client that requests various services. The other device implements the AP function in Wi-Fi through software settings. The software AP corresponds to the parent station in Wi-Fi, and the client corresponds to the child station in Wi-Fi. In the software AP mode, the client searches for a device serving as the software AP by issuing a device search command. When the software AP is discovered, the remaining wireless connection processes (such as establishing a wireless connection) are performed between the client and the software AP, followed by IP connection processes (such as assigning an IP address). The commands and parameters transmitted and received in implementing a wireless connection between the client and the software AP may be those defined in the Wi-Fi standard, and the descriptions are omitted here.

In the present embodiment, when the communication device 151 establishes and maintains a direct connection, the communication device 151 operates as the parent station in the network to which it belongs. The parent station is a device constituting a wireless network and provides parameters for use in connecting to the wireless network to the child station. The parameters for use in connecting to the wireless network are, for example, parameters related to a channel to be used by the parent station. The child station receives the parameters, thereby connecting to the wireless network constituted by the parent station using the channel used by the parent station. To operate as the parent station in the direct connection mode, the communication device 151 can determine what frequency band and what channel are to be used for communication. In the present embodiment, when communicating in the direct connection mode, the communication device 151 can use a channel corresponding to a frequency band of 2.4 GHz or a channel corresponding to a frequency band of 5 GHz.

### Infrastructure Connection Scheme

The infrastructure connection is a connection configuration for connecting to an AP (for example, the AP 131) that manages the network of devices (for example, the terminal device 101 and the communication device 151) to enable the devices to communicate with each other via the AP. The communication device 151 is also operable in the infrastructure connection mode, which is one of the connection modes for communication via an infrastructure connection.

In the infrastructure connection mode, the devices search for an AP by issuing a device search command. When the AP is discovered, the remaining wireless connection processes (such as establishing a wireless connection) between each device and the AP are performed, followed by IP connection processes (such as assigning an IP address). The commands and parameters transmitted and received in implementing a wireless connection between the device and the AP may be those defined in the Wi-Fi standard, and the descriptions are omitted here.

In the present embodiment, when the communication device 151 operates in the infrastructure connection mode, the AP 131 operates as the parent station, and the communication device 151 operates as the child station. In other words, in the present embodiment, the infrastructure connection refers to a connection between the communication device 151 that operates as the child station and a device that operates as the parent station. When the communication device 151 has established an infrastructure connection, and the terminal device 101 has also established an infrastructure connection to the AP 131, communication between the communication device 151 and the terminal device 101 via the AP 131 is possible. Since a channel for use in communication via the infrastructure connection is determined by the AP 131, the communication device 151 executes communication via the infrastructure connection using the channel determined by the AP 131. In the present embodiment, the communication device 151 can use a channel corresponding to a frequency band of 2.4 GHz or a channel corresponding to a frequency band of 5 GHz for communication via the infrastructure connection. The communication device 151 can also use a channel corresponding to a dynamic frequency selection (DFS) band in the frequency band of 5 GHz for communication via the infrastructure connection. The terminal device 101 recognizes and identifies the communication device 151 that belongs to the network, which is configured by the AP 131 and to which the terminal device 101 belongs, in order to communicate with the communication device 151 via the AP 131.

### Connection Setting Process

In the present embodiment, the terminal device 101 executes connection settings (network settings) for operating the communication device 151 via at least one of the infrastructure connection or the direct connection using wireless communication with the communication device 151. The connection setting process according to the present embodiment is executed via wireless communication and is therefore also referred to as cableless setup (CLS). The connection setting process may be executed via wired communication. The terminal device 101 performs the connection setting process on the communication device 151 when the first application stored in, for example, the external storage device 106, is executed. The communication device 151 is operable in a connection setting mode (a connection setting state) for executing the connection setting process and executes the connection setting process during operation in the connection setting mode, described later.

When operating the communication device 151 in the infrastructure connection mode, the terminal device 101 wirelessly transmits infrastructure setting information, which is setting information for operating the communication device 151 in the infrastructure connection mode, to the communication device 151. The infrastructure setting information includes information about the AP 131. Examples of the information about the AP 131 include information about a service set identifier (SSID), a password, and a frequency band.

In contrast, when operating the communication device 151 in the direct connection mode, the terminal device 101 wirelessly transmits direct setting information, which is setting information for operating the communication device 151 in the direct connection mode, to the communication device 151. The direct setting information includes instructions for enabling the WFD function to operate the communication device 151 as the Group Owner and enabling the access point setting of the communication device 151. The terminal device 101 acquires connection information necessary for directly connecting to the communication device 151 from the communication device 151. The connection information for directly connecting to the communication device 151 includes, for example, the SSID and the password of the communication device 151 operated in the direct connection mode.

In the present embodiment, to transmit the infrastructure setting information or the direct setting information and to acquire information for directly connecting to the communication device 151, the connection setting process uses a direct connection for setting a connection between the terminal device 101 and the communication device 151. Although the present embodiment executes a connection setting process using Wi-Fi as the direct connection for connection settings, a wireless communication standard other than Wi-Fi, such as Bluetooth, may be used. Alternatively, wired communication standards, such as a wired LAN or a universal serial bus (USB), may be used for the direct connection for connection settings.

After an infrastructure connection or a direct connection via Wi-Fi is established between the terminal device 101 and the communication device 151 by the connection setting process, communication between the terminal device 101 and the communication device 151 becomes possible via the established connection. Specifically, for example, the terminal device 101 can transmit to the communication device 151 via the established connection a print job for causing the communication device 151 to execute printing or a scan job for causing the communication device 151 to execute scanning. In the present embodiment, the communication device 151 can be operated either in the infrastructure connection mode or in the direct connection mode through the connection setting process; however, this configuration is illustrative only. For example, the communication device 151 may be operated only in the infrastructure connection mode (in other words, the communication device 151 cannot be operated in the direct connection mode) through the connection setting process.

### Connection Setting Mode

The communication device 151 is operable in the connection setting mode. A trigger to cause the communication device 151 to enter the connection setting mode may include, for example, the user pressing a button for the connection setting mode or the communication device 151 being activated (powered on) for the first time after shipment. The button for the connection setting mode may be either a hard button provided at the communication device 151 or a software button displayed on the display unit 161 by the communication device 151.

When the communication device 151 enters the connection setting mode, both of Wi-Fi communication and BLE communication are enabled. Specifically, the communication device 151 enables an AP (a connection setting AP) dedicated for the connection setting mode in the communication device 151 to enable Wi-Fi communication. This causes the communication device 151 to enter a state in which the direct connection to the terminal device 101 via Wi-Fi can be established. The connection information (the SSID and the password) for connecting to the connection setting AP is stored in advance in the first application installed in the terminal device 101. In other words, the terminal device 101 recognizes the connection information for connecting to the connection setting AP in advance. For this reason, unlike connection information about an AP enabled in the direct connection mode, the connection information for connecting to the connection setting AP cannot be freely changed by the user. The connection setting AP may not employ an encryption scheme and may not require a password for connecting to the AP. In the connection setting mode, the communication device 151 may connect to the terminal device 101 via Wi-Fi Direct (WFD), rather than common Wi-Fi. In other words, the communication device 151 may operate as the Group Owner and receive a setting command from the terminal device 101 through WFD communication.

Registering Communication Device with Application

In the present embodiment, the first application can register the communication device 151 with the first application by acquiring information regarding the communication device 151 from the communication device 151.

Examples of the information regarding the communication device 151 include capability information about the communication device 151, identification information (e.g., a MAC address) about the communication device 151, and model information about the communication device 151. The capability information about the communication device 151 includes, specifically, a list of information regarding the functions supported by the communication device 151, information regarding consumables available for the communication device 151 (ink and paper), and information indicating the printing method of the communication device 151. The first application selects a communication partner from one or multiple communication devices 151 registered with the first application. The communication device 151 currently selected as a communication partner by the first application is hereinafter referred to as a selected communication device 151. The selection of the communication partner device by the first application may be executed by receiving a user's selection from among one or multiple communication devices 151 registered with the first application or automatically executed by the first application according to a predetermined reference. Change of the communication partner device by the first application may be executed by receiving a user's selection from among one or multiple communication devices 151 registered with the first application. In the present embodiment, the first application transmits various jobs, such as a print job and a scan job, to the selected communication device 151. In other words, the selected communication device 151 is a device to which various jobs are transmitted.

### Problems Solved by Present Embodiment

To connect the communication device 151 to the AP through the connection setting process, the terminal device 101 transmits a password for use in connecting to the AP to the communication device 151. The communication device 151 connects to the AP using the received password. The password transmitted from the terminal device 101 to the communication device 151 in this process may be a password input to the terminal device 101 by the user. In this case, the user needs to remember a correct password and input it to the terminal device 101. However, there may be cases where the user remembers an incorrect password or mistakenly inputs an incorrect password to the terminal device 101 despite having remembered a correct password. As a result, an incorrect password is transmitted to the communication device 151, preventing the communication device 151 from connecting to the AP.

To solve such a problem, the terminal device 101 according to the present embodiment executes a process for preventing an incorrect password from being input to the terminal device 101. Specifically, the first application of the terminal device 101 displays a screen that presents a method for confirming a correct password on a screen displayed by a specific application of the terminal device 101. The specific application is an application different from the predetermined application and installed in advance on the terminal device 101 rather than being installed on the terminal device 101 via a store application. The specific application is a setting application for performing various settings of the terminal device 101, including settings for the Wi-Fi connection of the terminal device 101. In the following, a screen for performing settings for the Wi-Fi connection of the terminal device 101 is referred to as a Wi-Fi setting screen. In the following, the specific application is referred to as a second application. The second application can display a list of access points present around the terminal device 101 on the Wi-Fi setting screen. If a password is needed to connect to the access point selected from the list, the second application can receive the password input by the user on the Wi-Fi setting screen.

If the connection using the password has succeeded, the second application stores and manages various pieces of information about the access point connected to the terminal device 101 using the password. Specific examples of the various pieces of information include information regarding the password, SSID, and security. In other words, the second application has a management function for managing information about the access point to which the terminal device 101 is currently connected and information about access points to which the terminal device 101 has been connected in the past. In the management function, the second application can display, on the Wi-Fi setting screen, the password of the access point to which the terminal device 101 is currently connected and the passwords of access points to which the terminal device 101 has connected in the past. The user can confirm the correct password of the access point by confirming the password displayed by the second application. However, in order for the second application to display the password, several operations need to be performed on a screen displayed by the second application. Since terminal devices 101 include second applications that differ depending on the OS or model of the terminal device 101, an operation for displaying the password using the second application may vary depending on the OS or model of the terminal device 101. If the user does not correctly remember the operation, the user cannot display the password using the second application. For this reason, the present embodiment displays a screen that presents an operation for displaying the password via the second application.

In the case where the OS of the terminal device 101 is iOS® or iPadOS®, the connection to the terminal device 101 established in response to an instruction from the first application includes a connection that is disconnected based on the transition of the first application to the background (hereinafter referred to as a first type of connection) and a connection that is not disconnected even when the first application transitions to the background (hereinafter referred to as a second type of connection). Specifically, the first type of connection is disconnected by the OS after a predetermined amount of time (e.g., 15 seconds) has elapsed with the first application remaining in the background. The second type of connection is not disconnected by the OS and is maintained even when a predetermined amount of time passes with the first application remaining in the background. In the present embodiment, the first application displays a screen that prompts the user to confirm the password on the Wi-Fi setting screen displayed by the second application. When the user activates the second application to display the Wi-Fi setting screen, the first application transitions to the background. In the case where the connection between the communication device 151 operating in the connection setting mode and the terminal device 101 is the first type of connection, when the user activates the second application to confirm the password, the connection between the communication device 151 operating in the connection setting mode and the terminal device 101 is disconnected. When the connection is disconnected, even when the user confirms the password on the Wi-Fi setting screen displayed by the second application and inputs the password into the first application, the first application cannot transmit the input password to the communication device 151. In order to transmit the input password to the communication device 151, the connection needs to be re-established. This requires an operation for re-establishing the connection, which is bothersome for the user. For this reason, in the present embodiment, control is performed so that the connection between the communication device 151 operating in the connection setting mode and the terminal device 101 becomes the second type of connection. This allows the connection to be maintained without being disconnected even when the first application transitions to the background by the user activating the second application.

As described above, the first application allows the user to confirm the connection between the communication device 151 and the AP by transmitting setting information including the password input to the first application by the user to the communication device 151. However, the user may abandon the method in which the first application transmits setting information to the communication device 151 due to reasons such as a failure to confirm the password even when a password input screen is displayed by the first application. There may also be another method (another connection method) for establishing a connection between the communication device 151 and another device, different from the method in which the first application transmits setting information to the communication device 151. However, if the user does not recognize the presence or the details of another connection method, the user will fail to establish the connection to the communication device 151 by either the method in which the first application transmits setting information to the communication device 151 or another connection method. For this reason, the present embodiment displays a button for displaying a manual for another connection method on the password input screen. This improves usability by guiding a user who gave up the method in which the first application transmits setting information to the communication device 151 to use another connection method even when a password input screen is displayed by the first application.

It is to be understood that the present disclosure does not necessarily have to solve all the above problems, it is sufficient that any of the above problems is solved. In other words, not all of the processes for solving the above problems have to be executed, and it is sufficient that any of the processes for solving the above problems is executed.

### Process Executed by First Application in the Present Embodiment

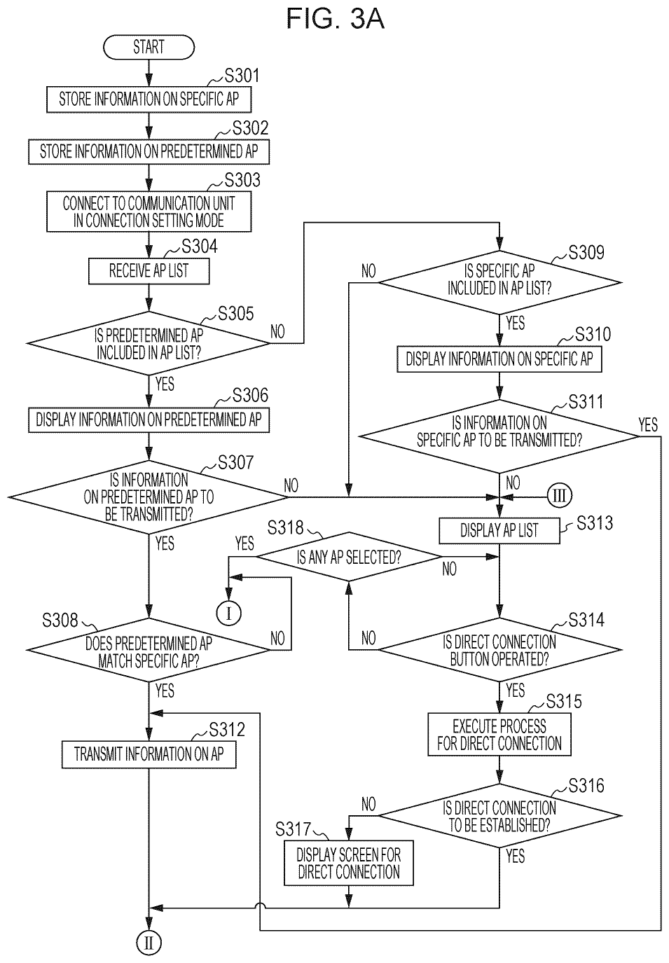

FIGS. 3A and 3B show a flowchart illustrating an example of processing executed by the terminal device 101 using the first application in the present embodiment. The processes in the flowchart of FIGS. 3A and 3B are implemented by, for example, the CPU 103 executing the first application, which has been loaded into the RAM 105 from a memory such as the ROM 104. The processing illustrated in the flowchart of FIGS. 3A and 3B begins when an operation for executing the connection setting process is performed on a screen displayed by the first application. The processing illustrated in the flowchart of FIGS. 3A and 3B may also begin when the first application is activated.

In S301, the first application acquires information about an AP to which the selected communication device 151 is currently connected via Wi-Fi from the communication device 151 and stores it. Hereinafter, the AP to which the selected communication device 151 is currently connected is referred to as a specific AP. The information about the specific AP acquired at this step includes the SSID and the password. The information about the specific AP is acquired via an infrastructure connection or a direct connection between the terminal device 101 and the communication device 151. If the terminal device 101 is currently uncommunicable with the selected communication device 151 or if the selected communication device 151 is not currently connected to the AP via Wi-Fi, the information about the specific AP is not acquired. The timing of when the information about the specific AP is acquired is not limited to this timing. For example, the information about the specific AP may be acquired in response to the activation of the first application at a timing before the processing illustrated in the flowchart of FIGS. 3A and 3B begins. In such a configuration, the process of S301 is skipped.

In S302, the first application acquires information about the AP to which the terminal device 101 is currently connected via Wi-Fi from the OS and stores it. The AP to which the terminal device 101 is currently connected via Wi-Fi is, in other words, an AP to which the terminal device 101 is connected when a process that triggers the start of the processing illustrated in the flowchart of FIGS. 3A and 3B is executed. The process that triggers the start of the processing illustrated in the flowchart of FIGS. 3A and 3B is reception of an operation for executing the connection setting process or activation of the first application. Hereinafter, the AP to which the terminal device 101 is connected via Wi-Fi at the timing of S302 is referred to as a predetermined AP. The AP information acquired at this step is part of various pieces of AP information that the first application can acquire from the OS. A specific example of such AP information is the SSID. If the terminal device 101 is not currently connected to the AP via Wi-Fi, the information about the predetermined AP is not acquired.

In S303, the first application executes a process for establishing a connection between the communication device 151 operating in the connection setting mode and the terminal device 101. Specifically, the first application instructs the OS to establish a connection between the communication device 151 operating in the connection setting mode and the terminal device 101. More specifically, the first application invokes a predetermined application programming interface (API) for establishing a connection to the terminal device 101, while setting at least a part of the character string of the SSID of the communication device 151 operating in the connection setting mode as an argument. Then, the OS searches for a device having an SSID including the character string and establishes a connection between the discovered device (that is, the communication device 151 operating in the connection setting mode) and the terminal device 101. The communication device 151 to which the terminal device 101 is connected through this process is a communication device 151 that is discovered first in the search executed by the process of S303. However, this configuration is illustrative only. Multiple communication devices 151 discovered through the search executed by the process of S303 may be displayed by the first application, and one of the multiple communication devices 151 selected by the user may be accepted. The communication device 151 to which the terminal device 101 is connected by this process may be a communication device 151 selected by the user. While the connection between the communication device 151 operating in the connection setting mode and the terminal device 101 is maintained, communication between the communication device 151 and the terminal device 101 is executed via the connection.

In the present embodiment, the first application for iOS performs control so that the connection between the communication device 151 operating in the connection setting mode and the terminal device 101 is the second type of connection. Specifically, in S303, the first application for iOS sets a flag for instructing the OS to establish the second type of connection and invokes a predetermined API. This allows the OS to establish a connection between the communication device 151 operating in the connection setting mode and the terminal device 101 as the second type of connection. As a result, even when a predetermined time has elapsed with the first application operating in the background, the connection between the communication device 151 operating in the connection setting mode and the terminal device 101 is not disconnected. In the case where the OS of the terminal device 101 is an Android OS®, all connections to the terminal device 101 established in response to the instruction of the first application are the second type of connection. For this reason, in the case where the first application is an application for an Android OS, it is not necessary to set a flag for instructing the OS to establish the second type of connection.

In S304, the first application acquires from the communication device 151 information regarding a list of APs discovered through a search executed by the communication device 151. The APs discovered through the search executed by the communication device 151 are APs to which the communication device 151 can connect. The APs to which the communication device 151 can connect are APs that are located within the communication range of the communication device 151 and that support the capability of the communication device 151. For example, in the case where the communication device 151 is capable of communication via 2.4 GHz but incapable of communication via 5 GHz, the list of APs indicated by the acquired information includes APs that support communication via 2.4 GHz but does not include APs that support communication via 5 GHz.

In S305, the first application determines whether the list of APs indicated by the information acquired in S304 includes the AP indicated by the information stored in S302 (the predetermined AP). If the first application determines that the result is YES, the processing proceeds to S306; if the determination result is No, the processing proceeds to S309.

In S306, the first application displays a confirmation screen that displays information about the predetermined AP to prompt the user to confirm whether to set the predetermined AP as the connection target of the communication device 151. The information displayed here is the information stored in S302; for example, the SSID of the predetermined AP.

In S307, the first application determines whether to transmit the information about the predetermined AP to the communication device 151. In other words, this is a determination as to whether the user has confirmed that the connection target of the communication device 151 is the predetermined AP. Therefore, if an input indicating that the predetermined AP is set as the connection target of the communication device 151 is performed on the confirmation screen, the result is determined to be YES, and the predetermined AP is identified as the connection target of the communication device 151. If an input indicating that the predetermined AP is not set as the connection target of the communication device 151 is performed on the confirmation screen, the result is determined to be NO. If the first application determines that the result is YES, the processing proceeds to S308; if the determination result is No, the processing proceeds to S313.

In S308, the first application determines whether the predetermined AP matches the specific AP. If the predetermined AP matches the specific AP, the first application is deemed to have stored the password of the predetermined AP. Therefore, this is a determination as to whether the first application has stored the password of the predetermined AP. In other words, this is a determination as to whether the password of the predetermined AP is stored in a storage area to which the first application can refer. If the first application determines that the result is YES, the processing proceeds to S312, where the information about the predetermined AP is transmitted to communication device 151; if the determination result is NO, the processing proceeds to S319, where a password input screen is displayed.

In S308, the determination as to whether the predetermined AP matches the specific AP does not necessarily have to be performed. The determination executed in S308 may be a determination as to whether the predetermined AP is an AP corresponding to the information stored in the storage area to which the first application can refer.

In this configuration, one example of the case where the determination result is YES is a case where, in a past connection setting process executed by the first application, a password for connecting to the predetermined AP has been input to the first application by the user and transmitted to the communication device 151. In this configuration, one example of the case where the determination result is NO is a case where, in a past connection setting process executed by the first application, a password for connecting to the predetermined AP has not been input to the first application by the user.

In S309, which is executed when the determination result of S305 is NO, the first application determines whether the AP indicated by the information stored in S301 (specific AP) is included in the list of APs indicated by the information acquired in S304. If the first application determines that the result is YES, the processing proceeds to S310; if the determination result is NO, the processing proceeds to S313.

In S310, the first application displays a confirmation screen that displays information about the specific AP to prompt the user to confirm whether to set the specific AP as the connection target of the communication device 151. The information displayed at this step is the information stored in S301; for example, the SSID of the specific AP.

In S311, the first application determines whether to transmit the information about the specific AP to the communication device 151. In other words, this is a determination as to whether the user has confirmed that the connection target of the communication device 151 is the specific AP. Therefore, if an input indicating that the specific AP is set as the connection target of the communication device 151 is performed on the confirmation screen, the result is determined to be YES, and the specific AP is identified as the connection target of the communication device 151. If an input indicating that the specific AP is not set as the connection target of the communication device 151 is performed on the confirmation screen, the result is determined to be NO. If the first application determines that the result is YES, the processing proceeds to S312; if the determination result is No, the processing proceeds to S313.

In S312, the first application transmits to the communication device 151 information for connecting to the AP identified as the connection target of the communication device 151. The information transmitted at this step includes the SSID of the AP identified as the connection target of the communication device 151 and the password for connecting to the AP identified as the connection target of the communication device 151. In this process, the AP identified as the connection target of the communication device 151 is the predetermined AP that matches the specific AP, or it is the specific AP. In other words, the password transmitted at this step is the password of the specific AP, which is acquired from the communication device 151 in S301. In other words, the password transmitted at this step is a password stored by the first application (a password stored in the storage area to which the first application can refer). Accordingly, after the connection target of the communication device 151 is identified, the first application transmits the password to the communication device 151 without receiving input of the password from the user. After the information for connecting to the AP identified as the connection target of the communication device 151 is transmitted to the communication device 151, the communication device 151 terminates the connection setting mode and connects to the AP identified as the connection target of the communication device 151 using the received information. As a result of the termination of the connection setting mode, the connection between the communication device 151 and the terminal device 101 is disconnected. The terminal device 101 reconnects to the predetermined AP, which is the AP to which the terminal device 101 was connected before connecting to the communication device 151, using the reconnecting function of the OS. Thereafter, the first application proceeds to S327. The first application may instead proceed to the process of displaying a screen for searching for the communication device 151 on a Wi-Fi network to which the terminal device 101 is connected, as in S710 described later, rather than proceed to S327.

The process of S313 is executed when the determination result of S307 is NO, when the determination result of S309 is NO, when the determination result of S311 is NO, or when the determination result of S320 is YES. In S313, the first application displays the list of APs indicated by the information acquired in S304. In the present embodiment, the screen including the list also includes a direct-connection button. If the list does not include an AP that the user desires as the connection target of the communication device 151, the user may operate the direct-connection button.

In S314, the first application determines whether the direct-connection button has been operated. If the first application determines that the result is YES, the processing proceeds to S315; if the determination result is NO, the processing proceeds to S318.

In S315, the first application executes a process for establishing a direct connection between the communication device 151 and the terminal device 101. Specifically, the first application first transmits direct setting information to the communication device 151. The first application acquires connection information for directly connecting to the communication device 151. The first application instructs the OS to establish a connection between the communication device 151 operating in the direct connection mode and the terminal device 101. More specifically, the first application identifies the SSID of the communication device 151 operating in the direct connection mode from the received connection information. The first application invokes a predetermined API for establishing a connection to the terminal device 101 while setting at least a part of the character string of the identified SSID as an argument. Then, the OS searches for a device having an SSID including the character string and displays a confirmation screen for confirming whether to establish a direct connection between the discovered device (the communication device 151 operating in the direct connection mode) and the terminal device 101. If the first application is an application for iOS, in this process, the first application may invoke a predetermined API while setting a flag for instructing the OS to establish a connection that is not disconnected even when the first application has transitioned to the background. In other words, the direct connection between the communication device 151 and the terminal device 101 may be established as the second type of connection. However, this configuration is illustrative only. In this process, the first application may invoke the predetermined API without setting the flag and establish the direct connection between the communication device 151 and the terminal device 101 as the first type of connection.

In S316, the first application determines whether a user action to establish a direct connection has been performed on the confirmation screen displayed by the OS in S315. This determination is executed when the first application receives a notification from the OS indicating that an operation has been performed on the confirmation screen displayed by the OS. If a user action to establish a direct connection is performed, the OS establishes a direct connection. In contrast, if a user action not to establish a direct connection is performed, the OS does not establish a direct connection. If the first application determines that the result is YES, the processing proceeds to S327; if the determination result is NO, the processing proceeds to S317.

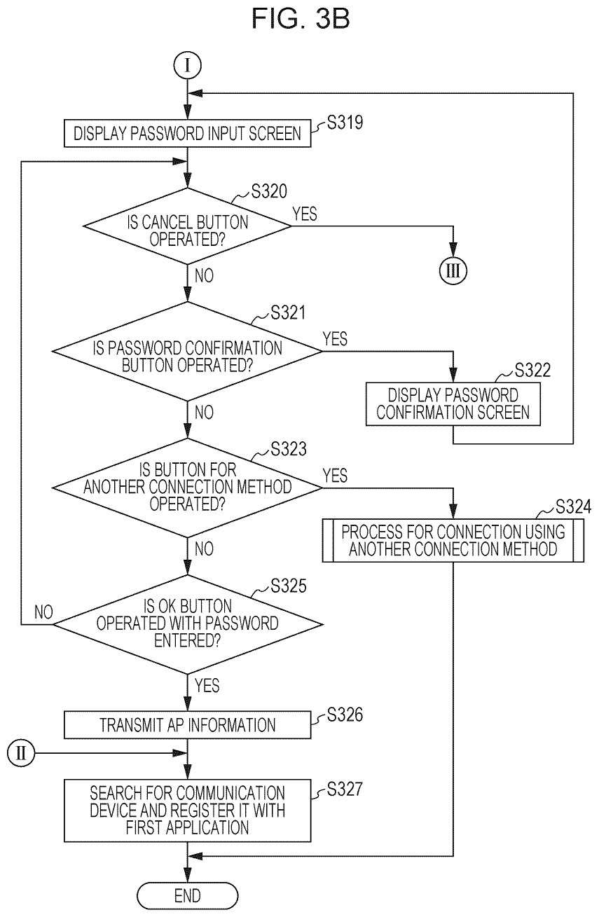

In S317, the first application displays a screen for a direct connection. One example of the screen displayed in this process is illustrated in FIG. 4. A screen 400 includes an SSID display area 401, a password display area 402, a password copy area 403, and a Completed button 404. The SSID display area 401 is configured to display the SSID of the communication device 151 operating in the direct connection mode. The password display area 402 is configured to display the password of the communication device 151 operating in the direct connection mode. When the area 403 is operated, the first application copies the password of the communication device 151 operating in the direct connection mode and stores the password in the clipboard of the terminal device 101. Copying the password of the communication device 151 operating in the direct connection mode allows the user to easily input the password in the second application, thereby establishing a direct connection via the second application. The screen 400 may include a message prompting the user to establish a direct connection on a Wi-Fi setting screen displayed by the second application and a message prompting the user to press the Completed button 404 upon successful establishment of the direct connection. When the Completed button 404 is pressed, the first application proceeds to S327. The processing may instead proceed to the process of displaying a screen for searching for the communication device 151 on a Wi-Fi network to which the terminal device 101 is connected, as in S710 described later, rather than proceed to S327.

In S318, which is executed when the determination result of S314 is NO, the first application determines whether any AP from the displayed AP list has been selected by the user. If the determination result is YES, the first application identifies the selected AP as the connection target of the communication device 151 and proceeds to S319; if the determination result is NO, the processing returns to S314, where the first application waits for any operation.

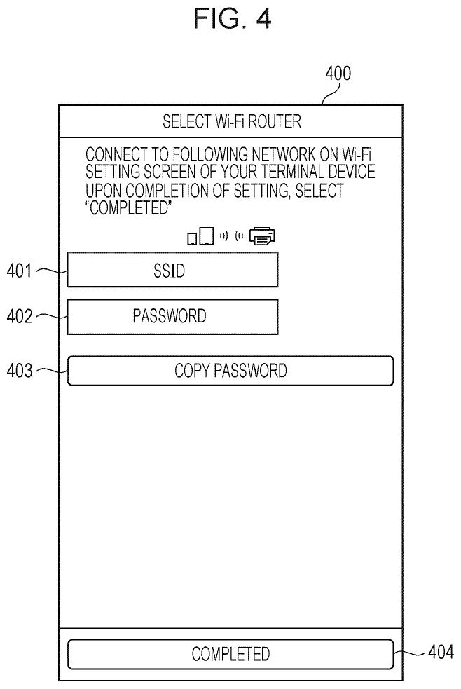

In S319, the first application displays a password input screen configured to receive a password for connecting to the AP identified as the connection target of the communication device 151 (first display control). The password input screen may be displayed as a pop-up on top of the AP list. One example of the screen displayed in this process is illustrated in FIG. 5. A password input screen 500 includes an SSID display area 501, a password input box 502 (a first area), a password confirmation button 503, a button 504 for another connection method, an OK button 506, and a Cancel button 505. The SSID display area 501 is an area that displays the SSID of an AP identified as the connection target of the communication device 151. The password input box 502 is configured to accept user input of the password of the AP identified as the connection target of the communication device 151. The password confirmation button 503 is a button relating to the function of displaying the password on the Wi-Fi setting screen via the second application. The button 504 for another connection method is a button for displaying a manual for another connection method. In the present embodiment, another connection method refers to a connection method different from the method in which the first application transmits setting information to the communication device 151 to establish a connection between the communication device 151 and another device. In other words, another connection method is a method for establishing a connection between the communication device 151 and another device without the first application transmitting setting information to the communication device 151.

Depending on the version of the OS of the terminal device 101, the second application may be unable to display on the Wi-Fi setting screen the password of an access point to which the terminal device 101 is currently connected or the password of an access point to which the terminal device 101 has connected in the past. Specifically, if the OS of the terminal device 101 is a version earlier than Android 10, a version earlier than iOS 16, or a version earlier than iPadOS 16, the second application cannot display the password on the Wi-Fi setting screen.

For this reason, in S319, the first application may identify the version of the OS of the terminal device 101 and determine whether the identified version is a version in which the second application is unable to display the password on the Wi-Fi setting screen. If the determination result is YES, the first application may display a password input screen not including the password confirmation button 503; if the determination result is NO, the first application may display a password input screen including the password confirmation button 503. The password input screen not including the password confirmation button 503 includes the other buttons and areas shown on the screen 500 of FIG. 5. In other words, the button 504 for another connection method is displayed regardless of the version of the OS. If the first application supports only an OS version in which the second application can display the password on the Wi-Fi setting screen, the determination of the OS version and the control to change the layout of the password input screen 500 based on the OS version determination result may be omitted.

In S320, the first application determines whether a user action on the Cancel button 505 has been accepted. If the first application determines that the result is YES, the processing proceeds to S313 and displays the AP list; if the determination result is NO, the processing proceeds to S321.

In S321, the first application determines whether a user action on the password confirmation button 503 has been accepted. If the first application determines that the result is YES, the processing proceeds to S322; if the determination result is NO, the processing proceeds to S323.

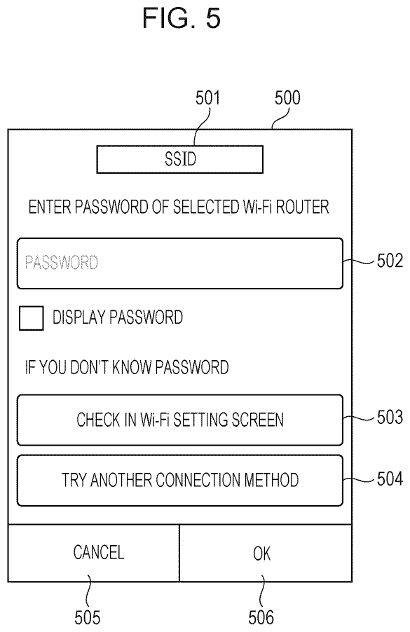

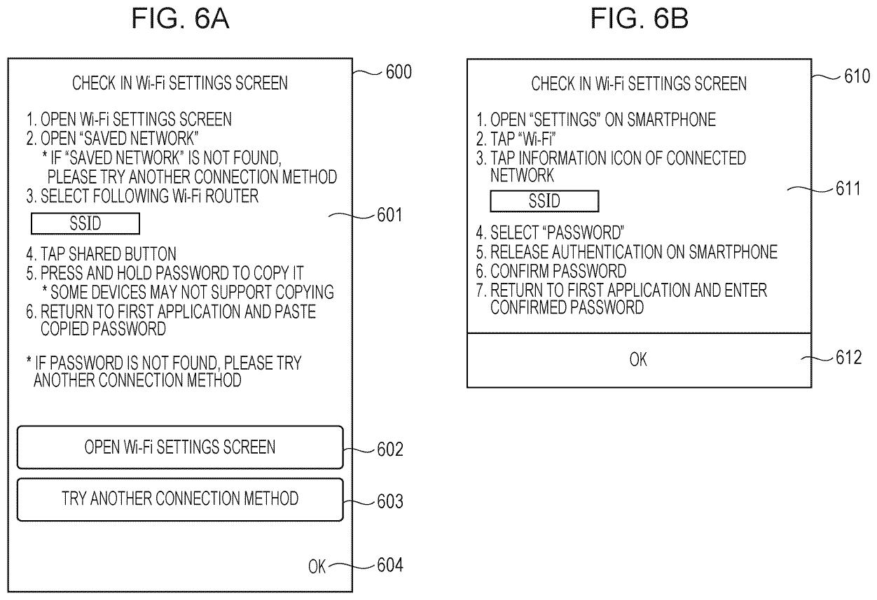

In S322, the first application displays a screen for confirming the password. In the present embodiment, a password confirmation screen is a predetermined screen that presents a method for confirming the password of the AP on the Wi-Fi setting screen displayed by the second application. One example of the screen displayed in this process is illustrated in FIGS. 6A and 6B. In the present embodiment, the password confirmation screen is not a web page displayed by a web browser via Internet communication. In other words, the screen is displayed by the first application in accordance with information stored in the first application. Examples of the web browser include an internal browser of the first application and the browser of a browser application different from the first application. However, this configuration is illustrative only; the password confirmation screen may be a web page displayed by a web browser. The password confirmation screen may be displayed in pop-up on top of the AP list.

FIG. 6A illustrates a password confirmation screen displayed when the OS of the terminal device 101 is Android OS, and the first application is an application for Android OS. A screen 600 includes an area 601 that presents a method for confirming the password of the AP on a Wi-Fi setting screen displayed by the second application compatible with Android OS (hereinafter referred to as a first password confirmation method), a button 602 that causes the second application to display the Wi-Fi setting screen, a button 603 for another connection method, and an OK button 604. The area 601 displays a description of an operation for confirming the password on the Wi-Fi setting screen compatible with Android OS as a description of the first password confirmation method. Specific examples include a message to open the Wi-Fi setting screen, a message to select a wireless LAN router (Wi-Fi router) activating an AP identified as the connection target of the communication device 151, and a message to tap a shared button for displaying the password of the selected router on the Wi-Fi setting screen. The area 601 may display the SSID of the AP identified as the connection target of the communication device 151. The SSID of the AP identified as the connection target of the communication device 151 is, in other words, the SSID of the AP corresponding to the password, which is the confirmation target on the Wi-Fi setting screen. The area 601 also displays a message to copy the password displayed on the Wi-Fi setting screen and a message to paste the copied password into the first application. The area 601 may also display a message prompting the user to, after confirming the password, return to the first application (to cause the first application to re-transition to the foreground). Depending on the type of the terminal device 101 (the type of the Android terminal), a function for confirming the password on the Wi-Fi setting screen or a function for copying the password displayed on the Wi-Fi setting screen may not be installed. For this reason, the screen 600 may include a message indicating the same. The screen 600 may include a message prompting the user to try another connection method when the password cannot be confirmed on the Wi-Fi setting screen. If the button 602 is operated, the second application is activated, and a process for causing the second application to display the Wi-Fi setting screen is executed. If the Wi-Fi setting screen is displayed, the first application transitions to the background. If a Backward button of the terminal device 101 is operated on the screen displayed by the second application, the first application re-transitions to the foreground. If the button 603 is operated, the first application proceeds to S324. If the OK button 604 is operated, the first application proceeds to S319.

FIG. 6B illustrates a password confirmation screen displayed when the OS of the terminal device 101 is iOS or iPadOS, and the first application is an application for iOS or an application for iPadOS. A screen 610 includes an area 611 that presents a method for confirming the password of the AP on a Wi-Fi setting screen displayed by the second application compatible with iOS or iPadOS (hereinafter referred to as a second password confirmation method), and an OK button 612.

The area 611 displays a description of an operation for confirming the password on a Wi-Fi setting screen compatible with iOS or iPadOS as a description of the second password confirmation method. The screen 610 may display the SSID of an AP identified as the connection target of the communication device 151. The area 611 may also display a message prompting the user to, after confirming the password, return to the first application (to cause the first application to re-transition to the foreground). The user, after confirming the message, activates the second application via the home screen or the like of the terminal device 101 and executes the operation indicated by the messages to confirm the password. After confirming the password, the user returns the first application to the foreground and operates the button 612 to input the password on the first application. All terminal devices equipped with a predetermined version or later of iOS or iPadOS are equipped with a function for confirming the password on the Wi-Fi setting screen. For this reason, the screen 610 does not include a button for another connection method, unlike the screen 600. However, this configuration is illustrative only; the screen 610 may also include a button for another connection method. In the terminal device equipped with iOS or iPadOS, the second application cannot be launched in response to an instruction from the first application. For this reason, the screen 610 does not include a button for displaying the Wi-Fi setting screen, unlike the screen 600. However, this configuration is illustrative only; even in a terminal device equipped with iOS or iPadOS, if the second application can be launched in response to an instruction from the first application, the screen 610 may also include a button for displaying the Wi-Fi setting screen. When the button 612 is operated, the first application proceeds to S319. In the present embodiment, the description of the first password confirmation method and the description of the second password confirmation method differ. However, this configuration is illustrative only; the description of the first password confirmation method and the description of the second password confirmation method may be the same.

In S323, which is executed when the determination result of S321 is NO, the first application determines whether a user action on the button 504 for another connection method has been accepted. If the first application determines that the result is YES, the processing proceeds to S324; if the determination result is NO, the processing proceeds to S325. The details of the process of S324 will be described later.

In S325, the first application determines whether a user action on the OK button 506 has been accepted, with the password being input to the password input box 502. The user may, after operating the button 503 to confirm the password on the Wi-Fi setting screen according to the description displayed on the screen of FIG. 6A or 6B, input the password into the password input box 502. If the user has copied the password on the Wi-Fi setting screen and stored it in a clipboard, the user may input the stored password by pasting it in the password input box 502. If the first application determines that the result is YES, the processing proceeds to S326; if the determination result is NO, the processing returns to S320 and waits for a user action on the password input screen 500.

In S326, the first application transmits to the communication device 151 information for connecting to the AP identified as the connection target of the communication device 151. The information transmitted at this step includes, specifically, the password input to the input box 502 and the SSID of the AP identified as the connection target of the communication device 151. After the information for connecting to the AP identified as the connection target of the communication device 151 is transmitted to the communication device 151, the communication device 151 terminates the connection setting mode and connects to the AP identified as the connection target of the communication device 151 using the received information. Due to the termination of the connection setting mode, the connection between the communication device 151 and the terminal device 101 is also disconnected. The terminal device 101 reconnects to the predetermined AP, which is the AP to which the terminal device 101 was connected before connecting to the communication device 151, using the reconnecting function of the OS. Thereafter, the first application proceeds to S327.

In S327, the first application searches for the communication device 151 on the Wi-Fi network to which the terminal device 101 is connected. For example, if the AP identified as the connection target of the communication device 151 is the predetermined AP, both the communication device 151 and the terminal device 101 are connected to the predetermined AP, and therefore, the communication device 151 is discovered by this search. If the AP identified as the connection target of the communication device 151 is an AP different from the predetermined AP, and the communication device 151 is connected to the AP different from the predetermined AP, or if the communication device 151 has failed to connect to the AP due to an incorrect password being entered, the communication device 151 is not discovered by this search. If the communication device 151 is discovered by this search, information about the communication device 151 is acquired from the communication device 151 via the Wi-Fi network to which the terminal device 101 is connected, and the communication device 151 is registered with the first application. At that time, the first application may automatically set the newly registered communication device 151 as a selected communication device 151. Thereafter, the first application terminates the process and displays the home screen of the first application.

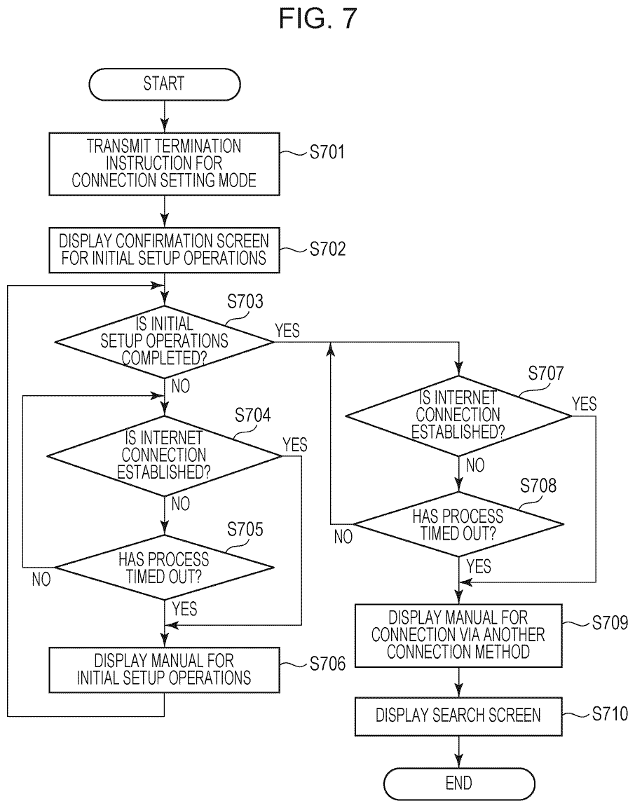

FIG. 7 is a flowchart illustrating an example of processing executed by the terminal device 101 using the first application in the present embodiment. The processes in the flowchart of FIG. 7 are implemented by, for example, the CPU 103 executing the first application, which has been loaded into the RAM 105 from a memory such as the ROM 104. The processing of this flowchart corresponds to the process of S324 shown in FIG. 3B.

In S701, the first application transmits information for instructing the communication device 151 to terminate processing in the connection setting mode. In response to it, the communication device 151 terminates the connection setting mode and restarts operation in a mode it was before the connection setting mode. Due to the termination of the connection setting mode, the connection between the communication device 151 and the terminal device 101 is also disconnected. The terminal device 101 reconnects to the predetermined AP, which is the AP to which the terminal device 101 was connected before connecting to the communication device 151, using the reconnecting function of the OS.

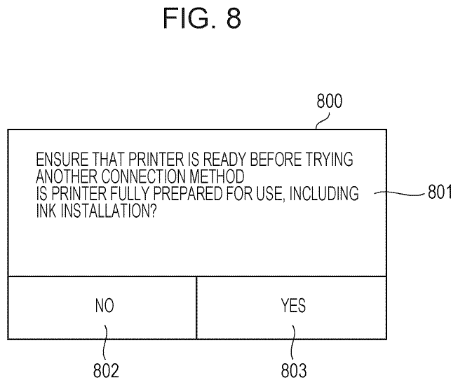

In S702, the first application displays a confirmation screen prompting the user to confirm whether the initial setup operations for the communication device 151 have been completed. The initial setup operations for the communication device 151 are operations executed at the time of initial power-on (shipment) of the communication device 151. In the present embodiment, examples of the initial setup operations include removing an orange tape from the communication device 151, attaching a print head to the communication device 151, replenishing the communication device 151 with a recording material (ink or toner), replenishing the communication device 151 with paper, and setting date and time in the communication device 151. Examples of processes executed by the communication device 151 in response to the initial setup operations include cleaning the print head, detecting paper, a registration process (registration adjusting process), which is a process for adjusting the ink landing position on the paper when printing, and starting the operations in the connection setting mode. In other words, the confirmation screen is a screen prompting the user to confirm whether the initial setup processes by the communication device 151 have been completed. The operations included in the initial setup operations and the processes included in the initial setup processes are not limited to the above; they may differ depending on the type of the communication device 151 and the printing method. One example of the confirmation screen displayed at this step is illustrated in FIG. 8. The screen 800 includes a message 801, a NO button 802, and a YES button 803. The message 801 includes a message indicating that the initial setup operations for the communication device 151 need to be completed in order to try another connection method and a message prompting the user to confirm whether the initial setup operations for the communication device 151 have been completed.

If the initial setup operations for the communication device 151 have been completed, the user performs an operation on the YES button 803, and if the initial setup operations for the communication device 151 have not been completed, the user performs an operation on the NO button 802.

In S703, the first application determines whether a user action on the YES button 803 has been accepted. If a user action on the NO button 802 is accepted, the result of this determination is NO. If the first application determines that the result is YES, the processing proceeds to S707; if the determination result is NO, the processing proceeds to S704.

In S704, the first application determines whether the terminal device 101 is connected to the Internet. The reconnection process by the OS of the terminal device 101 is executed due to the disconnection between the communication device 151 and the terminal device 101 in S701, as described above; however, an operation on the confirmation screen may be performed before the completion of the reconnection to the predetermined AP via Wi-Fi. In other words, an operation on the confirmation screen may be performed in a state in which the terminal device 101 is not connected to the Internet via a Wi-Fi connection to the predetermined AP. In this case, no web page is displayed in the process of S706. This determination is executed to display a web page correctly in the process of S706. In this process, specifically, the first application invokes an API for confirming whether the terminal device 101 is connected to the Internet and receives a notification as to whether the terminal device 101 is connected to the Internet from the OS. The first application executes the determination based on the details indicated by the received notification. The notification from the OS indicates that, when the terminal device 101 is connected to the Internet via a Wi-Fi connection to the predetermined AP, the terminal device 101 is connected to the Internet.

Even when the terminal device 101 is not connected to the Internet via a Wi-Fi connection to the predetermined AP but is connected to the Internet via mobile data communication, the notification from the OS may indicate that the terminal device 101 is connected to the Internet. The process for this determination is not limited to the above. For example, depending on the OS of the terminal device 101, the first application may not receive a notification indicating whether the terminal device 101 is connected to the Internet from the OS. Specifically, for example, if the OS of the terminal device 101 is iOS or iPadOS, the first application can receive the notification, but if the OS of the terminal device 101 is Android OS, the first application cannot receive the notification. For this reason, in this determination, if the first application is an application for Android OS, the first application may invoke an API for determining the SSID of the AP to which the terminal device 101 is currently connected and receive a notification indicating the SSID of the AP to which the terminal device 101 is currently connected from the OS. If the received notification indicates an SSID different from the SSID of the AP enabled by the communication device 151 operating in the connection setting mode, the first application may determine that the result is YES, and if the received notification indicates the SSID of the AP enabled by the communication device 151 operating in the connection setting mode, the first application may determine that the result is NO. In other words, this determination may be a determination as to whether the terminal device 101 is currently connected to an AP different from the AP enabled by the communication device 151 operating in the connection setting mode. This determination may be executed even if the first application is an application for iOS or an application for iPadOS. In this determination, if the received notification indicates the SSID of the predetermined AP, the first application may determine that the result is YES, and if the received notification indicates an SSID different therefrom, the first application may determine that the result is NO. If the first application determines that the result is YES, the processing proceeds to S706; if the determination result is NO, the processing proceeds to S705.

In S705, the first application determines whether the elapsed time since the operation on the confirmation screen displayed in S702 was accepted has exceeded a predetermined threshold. In other words, the first application determines whether the elapsed time since the operation on the confirmation screen displayed in S702 was accepted has timed out. The predetermined threshold is, for example, 10 seconds. If the first application determines that the result is YES, the processing proceeds to S706; if the determination result is NO, the processing returns to S704.

In S706, the first application executes a process for displaying a manual for initial setup operations for the communication device 151. Specifically, the first application displays a web page that displays a manual for initial setup operations for the communication device 151 via an internal browser (an in-app browser) of the first application. Information for displaying the web page is acquired from a predetermined server via a connection to the Internet. Accordingly, if the terminal device 101 is connected to the Internet, the web page is successfully displayed. If the terminal device 101 is not connected to the Internet, the display of the web page fails, and therefore, a screen indicating that the terminal device 101 is not connected to the Internet is displayed by the browser. In the present embodiment, by displaying a web page using the internal browser of the first application, the first application can continue to operate in the foreground. The manual for the initial setup operations of the communication device 151 includes content describing a specific operation method for the user to execute the initial setup operations of the communication device 151. The first application may display a web page for selecting the model of the communication device 151 before displaying the web page for displaying the manual for the initial setup operations of the communication device 151. When the model is selected on the page, a manual for initial setup operations corresponding to the selected model may be displayed. The manual for the initial setup operations of the communication device 151 may be displayed using a browser outside the first application, rather than the internal browser of the first application. In this case, the external browser for displaying the manual transitions to the foreground, and the first application transitions to the background. The manual for the initial setup operations of the communication device 151 may be displayed by the first application as content originally incorporated in the first application without using a browser, rather than being displayed as a web page acquired via the Internet. The screen displayed by the internal browser of the first application is closed when a Close button on the screen is operated by the user.

The screen displayed by the internal browser of the first application is displayed on the confirmation screen displayed in S702. Therefore, when the screen displayed by the internal browser of the first application is closed, the terminal device 101 becomes capable of accepting an operation on the confirmation screen again. For this reason, after the process in S706, the processing returns to S703.

In the above description, if the determination result of S705 is YES, the processing proceeds to S706; however, this configuration is illustrative only. If the determination result of S705 is YES, the first application may display a message indicating that the terminal device 101 is not connected to the Internet on the screen of the first application without trying to display a web page using a browser.

In S707, which is executed when the determination result of S703 is YES, the first application determines whether the terminal device 101 is connected to the Internet. This process is the same as S704. If the first application determines that the result is YES, the processing proceeds to S709; if the determination result is NO, the processing proceeds to S708.

In S708, the first application determines whether an elapsed time since the operation on the confirmation screen displayed in S702 is accepted has exceeded a predetermined threshold. This process is the same as S705. If the first application determines that the result is YES, the processing proceeds to S709; if the determination result is NO, the processing returns to S707.

In S709, the first application executes a process for displaying a manual for another connection method. Specifically, the first application displays a web page that displays a manual for another connection method via the internal browser (the in-app browser) of the first application. Information for displaying the web page is acquired from a predetermined server via a connection to the Internet. Accordingly, if the terminal device 101 is connected to the Internet, the web page is successfully displayed. If the terminal device 101 is not connected to the Internet, the display of the web page fails, and therefore, a screen indicating that the terminal device 101 is not connected to the Internet is displayed by the browser. In the present embodiment, by displaying a web page using the internal browser of the first application, the first application can continue to operate in the foreground. The manual for another connection method includes content describing a specific operation method for establishing a connection between the communication device 151 and the AP. Specific examples of another connection method include a method of displaying a list of APs discovered by a search executed by the communication device 151 on the screen of the communication device 151 and establishing a Wi-Fi connection between an AP selected from the displayed list by the user and the communication device 151. Specific examples of another connection method also include a method for establishing a Wi-Fi connection between an AP and the communication device 151 using Wi-Fi Protected Setup (WPS). Another specific example of another connection method includes a method for establishing a connection between an AP and the communication device 151 using a wired LAN cable. The first application may display a web page for selecting the model of the communication device 151 before displaying a web page that displays the manual for the initial setup operations of the communication device 151. When the model is selected on the page, a manual for another connection method corresponding to the selected model may be displayed. The manual for another connection method may be displayed using a browser outside the first application, rather than the internal browser of the first application. In this case, the external browser for displaying the manual transitions to the foreground, and the first application transitions to the background. The manual for another connection method may be displayed by the first application as content originally incorporated in the first application without using a browser, rather than being displayed as a web page acquired via the Internet.

In S710, the first application displays a search screen for searching for the communication device 151 on the Wi-Fi network to which the terminal device 101 is connected. The search screen is displayed under the internal browser, in which a web page is displayed. Therefore, the search screen is displayed when the internal browser is closed in response to an operation on the Close button. The search screen includes a button for prompting the user to start a search for the communication device 151 on the Wi-Fi network to which the terminal device 101 is connected. When the button is pressed, the first application searches for the communication device 151 on the Wi-Fi network to which the terminal device 101 is connected and displays a list of communication devices 151 discovered by the search. The first application displays only communication devices 151 corresponding to the first application among the multiple communication devices 151 discovered through the search. Communication devices 151 corresponding to the first application are communication devices 151 provided by the vendor of the first application. The search may be configured such that only communication devices 151 provided by the vendor of the first application are discovered, and communication devices 151 provided by other vendors are not discovered. When one of the listed communication devices 151 displayed is selected, the first application acquires information about the selected communication device 151 from the communication device 151 via the Wi-Fi network to which the terminal device 101 is connected and registers the selected communication device 151 with the first application. Then, the first application terminates the processing of this flowchart.

With this configuration, the first application can improve usability in confirming the password of the AP. The first application can also improve usability in confirming another connection method.

### OTHER EMBODIMENTS

The above embodiment describes a configuration in which the connection between the communication device 151 operating in the connection setting mode and the terminal device 101 is a Wi-Fi connection; however, this configuration is illustrative only. The connection between the communication device 151 operating in the connection setting mode and the terminal device 101 may be established using a communication scheme other than Wi-Fi, such as Bluetooth Classic or Bluetooth Low Energy. In this case, the terminal device 101 may maintain the Wi-Fi connection to the predetermined AP even while the connection between the communication device 151 operating in the connection setting mode and the terminal device 101 is established. In other words, in the configuration in which the connection between the communication device 151 operating in the connection setting mode and the terminal device 101 is a Wi-Fi connection, the predetermined AP is an AP to which the terminal device 101 is connected when the process that triggers the start of the processing illustrated in the flowchart of FIGS. 3A and 3B is executed, but to which the terminal device 101 is not connected when the information about the predetermined AP is transmitted to the communication device 151. In contrast, in the configuration in which the connection between the communication device 151 operating in the connection setting mode and the terminal device 101 is a connection using a communication scheme other than Wi-Fi, the predetermined AP is an AP to which the terminal device 101 is connected both when the information about the predetermined AP is transmitted to communication device 151 and when the process that triggers the start of the processing illustrated in the flowchart of FIGS. 3A and 3B is executed. In other words, the predetermined AP is an AP to which the terminal device 101 is connected at least when the process that triggers the start of the processing illustrated in the flowchart of FIGS. 3A and 3B is executed.

In the above embodiment, the process of referring to the specific AP may be omitted. Specifically, for example, the processes of S301 and S308 to S312 may be omitted. In this configuration, if the determination result of S305 is NO, S313 is executed. If the determination result of S307 is YES, S319 is executed.

In the above embodiment, both the process of referring to the predetermined AP and the process of referring to the specific AP may be omitted. Specifically, for example, the processes of S301, S302, and S305 to S312 may be omitted. In this configuration, S313 is executed after S304.

In the above embodiment, the direct-connection button does not necessarily have to be displayed on the screen displayed in S313. Specifically, for example, the processes from S314 to S317 may be omitted. In this configuration, S318 is executed after S313.

In the above embodiment, even if the OS of the terminal device 101 is of a version in which the password can be displayed on the Wi-Fi setting screen by the second application, both the password confirmation button 503 and the button 504 for another connection method need not have to be displayed on the password input screen displayed in S319. In other words, the password confirmation button 503 or the button 504 for another connection method may be displayed, and the other may not displayed on the password input screen displayed in S319. In a configuration in which the password confirmation button 503 is not displayed on the password input screen displayed in S319, the processes S321 and S322 are omitted, and if the determination result of S320 is NO, S323 is executed. In a configuration in which the button 504 for another connection method is not displayed on the password input screen displayed in S319, the processes S323 and S324 are omitted, and if the determination result of S321 is NO, S325 is executed.

The above embodiment describes a configuration in which the password confirmation button 503 is displayed on the password input screen as an area for confirming the password, and when the button is operated, a password confirmation screen is newly displayed; however, this configuration is illustrative only. An area in which a specific password confirmation method is described may be displayed on the password input screen as an area for confirming the password. In other words, the description displayed on the password confirmation screen in the above embodiment may be displayed on the password input screen. The description may be displayed on a screen separately displayed before the password input screen is displayed. In this configuration, the password confirmation button 503 does not have to be displayed on the password input screen 500.

The above embodiment describes a configuration in which the button 504 for another connection method is displayed on the password input screen as an area for another connection method, and when the button is operated, a screen for another connection method is newly displayed; however, this configuration is illustrative only. An area in which another connection method is described may be displayed on the password input screen as an area for another connection method. In other words, the description displayed on the screen for another connection method in the above embodiment may be displayed on the password input screen. The description may be displayed on a separately displayed screen before the password input screen is displayed. In this configuration, the button 504 for another connection method does not have to be displayed on the password input screen 500.

In the above embodiment, there is no particular limitation on the order of the determination of S320 to S325.

The above embodiment describes a configuration in which the AP list used in the determination of S305 and S309 and displayed in S313 is the list of APs discovered through a search executed by the communication device 151; however, this configuration is illustrative only. The AP list used in the determination of S305 and S309 and displayed in S313 may be a list of APs discovered through a search executed by the terminal device 101. In this configuration, the process of S304 may be omitted.

In the above embodiment, the process of referring to whether the initial setup operations for the communication device 151 have been completed may be omitted. Specifically, for example, the processes of S702 to S706 may be omitted. In this configuration, S707 is executed after S701.

The present disclosure improves the usability of application programs that perform processing for transmitting to a communication device information for connecting to an access point.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-107516, filed Jul. 3, 2024, the entirety of which is incorporated herein by reference.

What is claimed is:

1. A control method for an information processing apparatus including a first application program, the control method comprising the steps of:
displaying on a display unit of the information processing apparatus a password input screen including a first area configured to receive, from a user, an input of a password for connecting a communication device to an access point outside the information processing apparatus and a second area for presenting, to the user, a confirmation method for the user to confirm the password on a screen displayed on the display unit by a second application program different from the first application program; and
transmitting setting information including at least the password input by the user on the password input screen to the communication device via a connection between the information processing apparatus and the communication device,
wherein the communication device uses the setting information transmitted by the information processing apparatus to connect to the access point.

2. The control method according to claim 1, wherein the second area comprises a button for displaying a predetermined screen that includes a description of the confirmation method, wherein the predetermined screen is newly displayed in response to an operation on the button.

3. The control method according to claim 2, wherein the predetermined screen is displayed by the first application program without using a web browser.

4. The control method according to claim 2, wherein the predetermined screen includes an area configured to display a service set identifier (SSID) of the access point corresponding to the password to be confirmed on the screen displayed by the second application program.

5. The control method according to claim 4,
wherein the connection between the information processing apparatus and the communication device is established in response to the information processing apparatus receiving a predetermined operation by the user on a screen displayed by the first application program, and
wherein the access point corresponding to the password to be confirmed on the screen displayed by the second application program is an access point to which the information processing apparatus is connected when it receives the predetermined operation.

6. The control method according to claim 2, wherein the predetermined screen includes an area configured to display a message prompting the user to return to the first application program after confirming the password on the screen displayed by the second application program.

7. The control method according to claim 2, wherein the predetermined screen includes an area configured to display a message prompting the user to open the screen displayed by the second application program for presenting the confirmation method.

8. The control method according to claim 2, wherein, if an operating system (OS) of the information processing apparatus is a version prior to a predetermined version, the predetermined screen is not displayed in response to an operation performed on the button by the user, and if the OS of the information processing apparatus is the predetermined version or later, the predetermined screen is displayed in response to an operation performed on the button by the user.

9. The control method according to claim 8, wherein, if the OS of the information processing apparatus is a version prior to the predetermined version, the second area is not included on the password input screen, and if the OS of the information processing apparatus is the predetermined version or later, the second area is included on the password input screen.

10. The control method according to claim 9,
wherein the first application program is configured to be compatible with iOS®, iPadOS®, or Android OS®, and
wherein the predetermined version corresponding to iOS is iOS 16, the predetermined version corresponding to iPadOS is iPadOS 16, and the predetermined version corresponding to Android OS is Android 10.

11. The control method according to claim 1, wherein the second area includes a description of the confirmation method.

12. The control method according to claim 1, wherein the second application program is an application program for setting the information processing apparatus, the application program being installed in advance in the information processing apparatus rather than being installed in the information processing apparatus by a store application program.

13. The control method according to claim 1, further comprising the step of: displaying on the display unit of the information processing apparatus a first screen for presenting, to the user, an operation method for establishing a connection between the communication device and the access point that does not use the first application program to transmit the setting information to the communication device.

14. The control method according to claim 13, wherein the password input screen includes a third area comprising a button, and wherein the first screen is displayed in response to an operation performed on the button by the user.

15. The control method according to claim 1,
wherein the information processing apparatus is capable of establishing a first type of connection that is disconnected after a predetermined amount of time has elapsed since the first application program has transitioned to a background state and a second type of connection that is not disconnected even if the predetermined amount of time has elapsed since the first application program has transitioned to the background state, and
wherein the connection between the information processing apparatus and the communication device is the second type of connection.

16. The control method according to claim 15, wherein the first application program controls the information processing apparatus to establish the connection between the information processing apparatus and the communication device as the second type of connection by setting a predetermined flag for instructing establishment of the second type of connection and executing a predetermined application programming interface (API) for establishing the connection between the information processing apparatus and the communication device.

17. The control method according to claim 15, wherein the password input screen is displayed in a state in which the connection between the information processing apparatus and the communication device is established as the second type of connection.

18. The control method according to claim 1, further comprising the step of: transmitting to the communication device at least one of a print job for causing the communication device to execute printing or a scan job for causing the communication device to execute scanning.

19. A non-transitory computer-readable storage medium storing a first application program for causing a computer of an information processing apparatus to execute a control method comprising the steps of:
displaying on a display unit of the information processing apparatus a password input screen including a first area configured to receive, from a user, an input of a password for connecting a communication device to an access point outside the information processing apparatus and a second area for presenting, to the user, a confirmation method for the user to confirm the password on a screen displayed on the display unit by a second application program different from the first application programs; and
transmitting setting information including at least the password input by the user on the password input screen to the communication device via a connection between the information processing apparatus and the communication device,
wherein the communication device uses the setting information transmitted by the information processing apparatus to connect to the access point.

20. An information processing apparatus including a first application program, the information processing apparatus comprising:
a display unit configured to display a password input screen including a first area configured to receive, from a user, an input of a password for connecting a communication device to an access point outside the information processing apparatus and a second area for presenting, to the user, a confirmation method for the user to confirm the password on a screen displayed on the display unit by a second application program different from the first application program; and
a communication unit configured to transmit setting information including at least the password input by the user on the password input screen to the communication device via a connection between the information processing apparatus and the communication device,
wherein the communication device uses the setting information transmitted by the information processing apparatus to connect to the access point.
